(19) United States
(12) Patent Application Publication
(10) Pub. No.: US 2026/0119022 A1
(43) Pub. Date: Apr. 30, 2026

(54) DISPLAY METHOD, DISPLAY SYSTEM, AND NON-TRANSITORY COMPUTER-READABLE STORAGE MEDIUM STORING DISPLAY PROGRAM

(71) Applicant: SEIKO EPSON CORPORATION, Tokyo (JP)

(72) Inventors: Yasuhiro HONDA, SHIOJIRI-SHI (JP); Kiichiro GOTO, OITA-SHI (JP)

(21) Appl. No.: 19/367,119

(22) Filed: Oct. 23, 2025

(30) Foreign Application Priority Data
Oct. 24, 2024 (JP) 2024-187229

(51) Int. Cl. G06F 3/04845; G06F 3/0354; G06F 3/04817

(52) U.S. Cl. CPC G06F 3/04845; G06F 3/03545; G06F 3/04817

(57) ABSTRACT

A projection system executes, with a processor, determining whether a first pointer pointing a position on a display surface is a pointing pen, when it is determined that the first pointer is the pointing pen, causing the display surface to display a first image including a plurality of first icon images for receiving an operation instruction with the pointing pen , determining whether a second pointer pointing a position on the display surface is a finger of a user, and, when it is determined that the second pointer is the finger of the user, causing the display surface to display a second image including a plurality of second icon images for receiving an operation instruction by the finger of the user. An image having the smallest display size, which is one of the plurality of second icon images, is larger than an image having the smallest display size, which is one of the plurality of first icon images.

The present application is based on, and claims priority from JP Application Serial Number 2024-187229, filed October 24, 2024, the disclosure of which is hereby incorporated by reference herein in its entirety.

### BACKGROUND

### 1. Technical Field

The present disclosure relates to a display method, a display system, and a non-transitory computer-readable storage medium storing a display program.

### 2. Related Art

There has been known a display system including a GUI that receives operation by a finger of a user or operation by a touch pen.

JP-A-2015-132986 discloses that, in response to detection of a predetermined touch operation, a partial image displaying a setting state concerning processing executed by a controller is displayed, whereby a user can easily check what kind of processing is allocated to touch operation by a finger. In addition, JP-A-2015-132986 discloses that a partial image displaying a setting state concerning processing allocated to touch operation by a touch pen is displayed, whereby the user can easily check what kind of processing is currently allocated to pen operation.

JP-A-2015-132986 is an example of the related art.

However, in JP-A-2015-132986, when the operation by the finger of the user is performed using the partial image, in some cases, an image is slightly small for selection by the finger and it is difficult to perform selection operation. For this reason, operability by the finger of the user is sometimes deteriorated.

### SUMMARY

According to an aspect of the present disclosure, there is provided a display method including executing, with a processor: determining whether a first pointer pointing a position on a display surface is a pointing pen; when it is determined that the first pointer is the pointing pen, causing the display surface to display a first image including a plurality of first icon images for receiving an operation instruction with the pointing pen instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

According to an aspect of the present disclosure, there is provided a display system including a processor configured to execute: determining whether a first pointer pointing a position on a display surface is a pointing pen; when it is determined that the first pointer is the pointing pen, causing the display surface to display a first image including a plurality of first icon images for receiving an operation instruction with the pointing pen instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

According to an aspect of the present disclosure, there is provided a non-transitory computer-readable storage medium storing a display program for causing a processor to execute: determining whether a first pointer pointing a position on a display surface is a pointing pen; when it is determined that the first pointer is the pointing pen, causing the display surface to display a first image including a plurality of first icon images for receiving an operation instruction with the pointing pen instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

### BRIEF DESCRIPTION OF THE DRAWINGS

FIG. 1 is a perspective view illustrating an example of a system configuration of a projection system.

FIG. 2 is a side view illustrating an example of a side surface of the projection system.

FIG. 3 is a configuration diagram illustrating configuration examples of a projector and a first pointer.

FIG. 4 is a flowchart illustrating an operation example of the first controller.

FIG. 5 is a diagram illustrating an example of a first image.

FIG. 6 is a diagram illustrating an example of a second image.

FIG. 7 is a diagram illustrating a size of a smallest-size icon image.

FIG. 8 is a diagram illustrating a third image.

FIG. 9 is a diagram illustrating movement of the second image on a display surface.

FIG. 10 is a diagram illustrating display of a third image obtained by combining a first image and a second image.

### DESCRIPTION OF EMBODIMENTS

Hereinafter, an embodiment according to the present disclosure is explained in detail with reference to the drawings. However, detailed explanation more than necessary is sometimes omitted. For example, detailed explanation of already well-known matters or redundant explanation about substantially the same configuration is sometimes omitted.

In the explanation of the present disclosure, general abbreviations are sometimes used for the explanation. For example, GUI is an abbreviation for Graphical User Interface. LED is an abbreviation for Light Emitting Diode. CPU is an abbreviation for Central Processing Unit. GPU is an abbreviation for Graphics Processing Unit. ASIC is an abbreviation for Application Specific Integrated Circuit. FPGA is an abbreviation for Field Programmable Gate Array. LD is an abbreviation for Laser Diode. CMOS is an abbreviation for Complementary Metal Oxide Semiconductor. CCD is an abbreviation for Charge Coupled Device. RAM is an abbreviation for Random Access Memory. ROM is an abbreviation for Read Only Memory. MPU is an abbreviation for Micro Processor Unit. LSI is an abbreviation for Large Scale Integration. PLD is an abbreviation for Programmable Logic Device. MCU is an abbreviation for Micro Controller Unit. SoC is an abbreviation for System-on-a-Chip. DVD is an abbreviation for Digital Versatile Disc. USB is an abbreviation for Universal Serial Bus. SSD is an abbreviation for Solid State Drive.

### 1. Configuration of a projection system

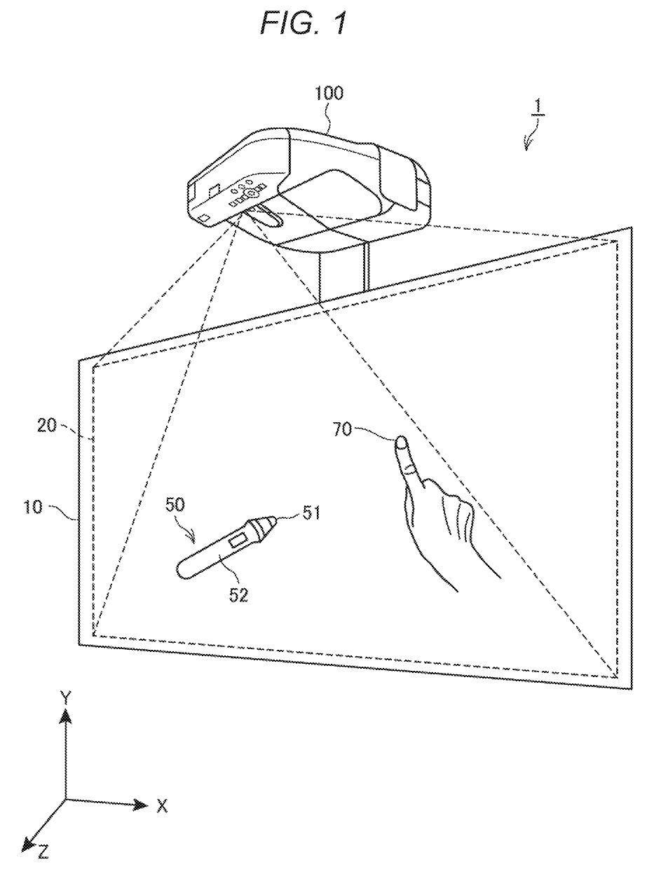

FIG. 1 is a perspective view illustrating an example of a system configuration of a projection system. As illustrated in FIG. 1, a projection system 1 includes a projector 100, a display surface 10 on which the projector 100 projects and displays an image, and a first pointer 50 used to designate a position on the display surface 10. The projection system 1 is an example of a display system. Designating a position on the display surface 10 can also be designation by a second pointer 70, which is a finger or the like of a user. In the following explanation, a normal line of the display surface 10 is represented as a Z axis, a vertical axis is represented as a Y axis, and an axis perpendicular to the Z axis and the Y axis is represented as an X axis.

The projector 100 generates image light corresponding to image data and projects the generated image light onto the display surface 10 to display an image. The projector 100 has an interactive function. The interactive function is a function of displaying an image corresponding to the positions and tracks of the first pointer 50 and the second pointer 70 based on detected positions of the first pointer 50 and the second pointer 70 or changing the displayed image.

The first pointer 50 is an example of a pointing pen held and used by the user and includes a tip 51 capable of emitting light and a shaft 52 gripped by the user. A light source such as an LED that emits near infrared light is mounted on the tip 51. The first pointer 50 emits light at a predetermined light emission interval in a touch state in which the tip 51 is in contact with the display surface 10. The first pointer 50 emits light at the predetermined light emission interval also in a state in which the tip 51 is not in contact with the display surface 10. Although one first pointer 50 is illustrated in FIG. 1, the number of first pointers 50 that can be simultaneously used is not limited to one and a plurality of first pointers 50 can also be simultaneously used.

Further, when the finger of the user is used as the second pointer 70, the user brings a tip such as a fingertip into contact with the display surface 10 to designate a position on the display surface 10. The projector 100 emits detection light along the display surface 10 and blocks the detection light when the tip of the second pointer 70 comes into contact with the display surface 10. This detection light is hereinafter referred to as second light 180. The second light 180 is reflected by the second pointer 70 and a part of reflected light of the second light 180 travels from the second pointer 70 toward the projector 100. The projector 100 detects the reflected light of the second light 180 reflected by the second pointer 70 and detects a position pointed by the second pointer 70.

For example, the projector 100 detects a change in the position of the first pointer 50 or the second pointer 70 in a state in which the first pointer 50 or the second pointer 70 is in contact with the display surface 10. The projector 100 can detect a change in the position of the first pointer 50 or the second pointer 70 in a state in which the first pointer 50 or the second pointer 70 is not in contact with the display surface 10. Here, the state in which the first pointer 50 or the second pointer 70 is not in contact with the display surface 10 means that the first pointer 50 or the second pointer 70 is present in a space in which a range of the display surface 10 is extended in the normal direction of the display surface 10. The distance in the normal direction at the time when the first pointer 50 or the second pointer 70 and the display surface 10 are not in contact is equal to or smaller than a predetermined threshold. That is, the change in the position of the first pointer 50 or the second pointer 70 in the state in which the first pointer 50 or the second pointer 70 is not in contact with the display surface 10 corresponds to a hovering motion of the first pointer 50 or the second pointer 70 in the vicinity of the display surface 10.

Consequently, the projector 100 can detect, for example, a character or a figure drawn on the display surface 10 by the first pointer 50 or the second pointer 70 in a state in which the first pointer 50 or the second pointer 70 is brought into contact with the display surface 10. The drawing of the character, the figure, or the like may include erasing the character, the figure, or the like with a function of an eraser. The projector 100 can detect, for example, a character or a figure drawn on the display surface 10 by the first pointer 50 or the second pointer 70 from a state in which the first pointer 50 or the second pointer 70 is not in contact with the display surface 10. The projector 100 can detect, for example, a hovering motion in which the position of the first pointer 50 or the second pointer 70 changes in a state in which the first pointer 50 or the second pointer 70 is not in contact with the display surface 10 and is separated from the display surface 10. As a specific example, the projector 100 can detect that a specific item is pointed by the first pointer 50 or the second pointer 70 out of a menu including a plurality of items displayed on the display surface 10.

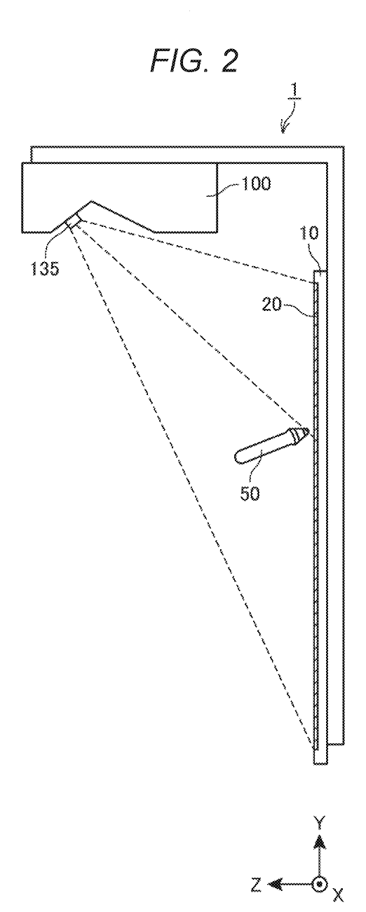

FIG. 2 is a side view illustrating an example of a side surface of the projection system 1. As illustrated in FIG. 2, the projector 100 according to the present embodiment is fixed to a wall surface and installed in front of and above the display surface 10 and projects image light toward the display surface 10 present obliquely below. A region of the display surface 10 onto which the image light is projected by the projector 100 is referred to as projection region 20. The projector 100 emits, in the direction corresponding to the display surface 10, the second light 180 used for detecting the first pointer 50 and the second pointer 70. Specifically, the direction is a direction in which reflected light reflected by the second pointer 70 approaching within a predetermined distance from the display surface 10 can be made incident on the imager 135. The second light 180 is light used for detecting the second pointer 70. In the present embodiment, infrared light is used as the second light 180. By using the infrared light, the second pointer 70 can be detected without being affected by image light mainly including visible light and display by the image light is not affected either. The second light 180 is emitted to a range including at least a part of the display surface 10. In the present embodiment, the second light 180 is emitted to a range covering the entire display surface 10.

### 2. Configuration of the projector

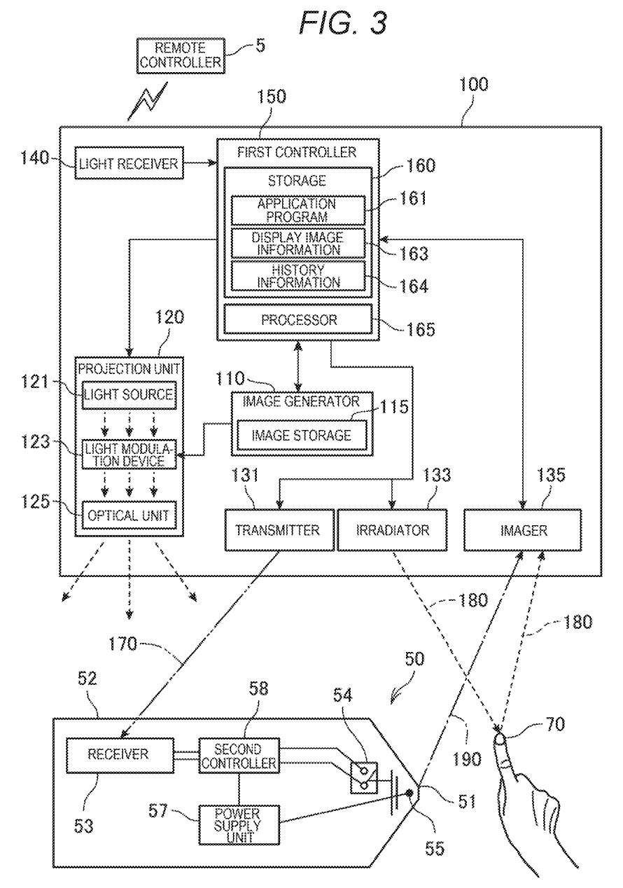

FIG. 3 is a configuration diagram illustrating configurations of the projector 100 and the first pointer 50. First, the configuration of the projector 100 is explained.

As illustrated in FIG. 3, the projector 100 includes an image generator 110, a projection unit 120, a transmitter 131, an irradiator 133, an imager 135, a light receiver 140, and a first controller 150.

The image generator 110 is an arithmetic processing device including a CPU or a GPU. The image generator 110 includes an image storage 115 that stores a projection image. The image storage 115 is a so-called frame memory that stores, in units of frames, an image projected by the projection unit 120.

The image generator 110 draws, based on image data, in the image storage 115, a projection image to be projected onto the display surface 10. The image generator 110 outputs an image signal indicating the image drawn in the image storage 115 to a light modulation device 123 and causes the projection unit 120 to project image light corresponding to the image data onto the display surface 10.

The image generator 110 executes image processing on an image to be drawn in the image storage 115. For example, the image generator 110 executes geometric correction processing for correcting trapezoidal distortion or the like of the projection region 20, digital zoom processing for enlarging or reducing a size of an image to be displayed on the display surface 10, color correction processing for correcting a color tone or the like of the image to be displayed on the display surface 10, and the like.

The projection unit 120 includes a light source 121, the light modulation device 123, and an optical unit 125.

The light source 121 includes a light source such as a xenon lamp, an ultra-high pressure mercury lamp, an LED, or a laser light source. The light source 121 may include a reflector and an auxiliary reflector that lead light emitted by the light source to the light modulation device 123.

The light modulation device 123 includes a modulation element such as a liquid crystal panel. The light modulation device 123 modulates, according to an image signal input from the image storage 115, light incident from the light source 121 to form image light. The image light is typically color image light including visible light of three colors of red (R), green (G), and blue (B).

The optical unit 125 projects the image light formed by the light modulation device 123 onto the display surface 10 to form an image on the display surface 10. The optical unit 125 includes at least one of a lens and a mirror. The optical unit 125 may include a zoom mechanism that enlarges or reduces an image to be projected onto the display surface 10 and a focus adjustment mechanism that adjusts a focus.

The transmitter 131 outputs signal light 170, which is a signal for synchronizing light emission timing of the first pointer 50 with imaging timing of the imager 135. The signal light 170 is indicated by an alternate long and two short dashes line in FIG. 3. The signal light 170 is a signal of near infrared light that the first pointer 50 can receive with a receiver 53. The transmitter 131 periodically transmits the signal light 170 while the projector 100 is in operation.

The signal light 170 is, for example, a control signal for designating timing for causing the first pointer 50 to transmit the first light 190. The first light 190 is near infrared light having a predetermined light emission pattern. In FIG. 3, the first light 190 is indicated by an alternate long and short dash line. The first pointer 50 transmits the first light 190 in synchronization with, for example, timing when the signal light 170 is received.

For this reason, the projector 100 is capable of causing the imager 135 to perform imaging to be timed to coincide with timing when the first pointer 50 emits the first light 190. The transmitter 131 includes, for example, a light source such as an LED and a device that controls turning on and turning off of the light source. The controlling device can include, for example, an ASIC or an FPGA.

The irradiator 133 emits, in a direction including the display surface 10, the second light 180 for detecting the first pointer 50 and the second pointer 70. The second light 180 is indicated by a broken line in FIG. 3. The irradiator 133 includes an LD or an LED as a light source that emits infrared light. The irradiator 133 may include an optical component that diffuses the infrared light emitted by the light source toward the display surface 10.

The imager 135 is a camera including an imaging element such as a CMOS or a CCD that receives near infrared light emitted by a light emitter 55 of the first pointer 50. The imager 135 includes an optical system that forms an image on the imaging element and a diaphragm that limits light incident on the imaging element.

The imager 135 images a range including the display surface 10 to generate a captured image. The imager 135 receives and images the first light 190 emitted by the first pointer 50. The captured image generated by the imager 135 is output to the first controller 150.

After performing the imaging, the imager 135 outputs an interrupt signal to the first controller 150. When receiving a response corresponding to the interrupt signal from the first controller 150, the imager 135 outputs the captured image to the first controller 150.

The light receiver 140 receives an infrared signal transmitted from a remote controller 5. The light receiver 140 generates an operation signal corresponding to the received infrared signal and outputs the generated operation signal to the first controller 150. The operation signal is a signal corresponding to a switch of the remote controller 5 operated by the user.

The first controller 150 includes a processor 165 such as a CPU, a storage 160 such as a memory, and various peripheral circuits. That is, the first controller 150 has a function serving as a computer. The storage 160 includes, for example, a volatile memory such as a RAM used as a work area of the processor 165 and a nonvolatile memory such as a ROM that stores programs and setting information in advance. The storage 160 stores information concerning a control program to be executed by the processor 165. The information concerning the control program includes an application program 161, display image information 163, and history information 164 besides firmware and calibration data.

In the projector 100, association of a captured image of the imager 135 and the projection region 20 of the display surface 10 is performed using the calibration data stored in the storage 160. More specifically, the calibration data is data in which coordinates of pixels in a coordinate system of the captured image and coordinates of pixels in a coordinate system of the image storage 115 are associated. The coordinates of the captured image are referred to as camera coordinates and the coordinates of the image storage 115 are referred to as panel coordinates. In the projector 100, by referring to the calibration data stored in the storage 160, a corresponding position of the projection region 20 is uniquely specified with respect to one position on the captured image.

The application program 161 is a program to be executed by the processor 165. The application program 161 is a program for implementing an interactive function. Specifically, the application program 161 is read and sequentially executed by the processor 165. Accordingly, the processor 165 executes various kinds of processing for displaying an image, a figure, a character, a symbol, and the like corresponding to a position on the display surface 10 pointed by the first pointer 50 and the second pointer 70.

The display image information 163 is information concerning an image to be displayed on the display surface 10. For example, the display image information 163 includes a plurality of icon images for receiving an operation instruction by the first pointer 50 or the second pointer 70 and information such as display sizes of the icon images. The display image information 163 includes a GUI image to be displayed to include a plurality of icon images and information such as a display size of the GUI image and arrangement positions of the icon images in the GUI image.

The history information 164 is information indicating a history of operations concerning the projector 100. For example, the history information 164 includes a history of operation instructions performed by the first pointer 50 or the second pointer 70 via the icon images or the like. More specifically, the history information 164 includes operation instructions such as selection, determination, enlargement, reduction, erasing, cancellation, and redoing and order of receiving the operation instructions.

The processor 165 includes, for example, a CPU or an MPU. The processor 165 executes a control program to control the units of the projector 100. The first controller 150 may include a plurality of processors.

The first controller 150 detects the first light 190 imaged in a captured image and reflected light of the second light 180 reflected by the second pointer 70. The first controller 150 analyzes a captured image generated by the imager 135 to specify pointed positions of the first pointer 50 and the second pointer 70. The first controller 150 generates coordinate information indicating a detected position of a light spot of the first light 190 and a detected position of a light spot of the reflected light of the second light 180. The coordinate information is represented by camera coordinates.

The first controller 150 converts the coordinate information represented by the camera coordinates into coordinate information of panel coordinates. This conversion is performed based on, for example, calibration data generated by calibration performed in advance.

The processor 165 reads and sequentially executes the application program 161, whereby the first controller 150 controls the units of the projector 100 to display an image on the display surface 10. The first controller 150 generates drawing data representing an image, a figure, a character, a symbol, or the like corresponding to tracks of positions on the display surface 10 pointed by the first pointer 50 and the second pointer 70. The first controller 150 outputs the generated drawing data to the image generator 110. The first controller 150 controls the image generator 110 to develop image data in coordinates on the image storage 115 based on the coordinate information after the conversion. Accordingly, the drawing data is superimposed on the image data and displayed on the display surface 10.

### 3. Configuration of the first pointer

Subsequently, a configuration of the first pointer 50 is explained.

As illustrated in FIG. 3, the first pointer 50 includes a tip 51, a shaft 52, a receiver 53, a tip switch 54, a light emitter 55, a power supply unit 57, and a second controller 58.

The receiver 53 includes a light receiving element that receives infrared light. The receiver 53 receives the signal light 170 transmitted by the projector 100. The receiver 53 outputs, to the second controller 58, a control signal or the like indicating timing when the signal light 170 is received.

The tip switch 54 is a switch that is turned on when the tip 51 comes into contact with the display surface 10 and is pressed and is turned off when the contact between the tip 51 and the display surface 10 is released.

The light emitter 55 includes an LED that emits near infrared light, is controlled to emit light by the second controller 58, and outputs the first light 190, which is the near infrared light.

The power supply unit 57 includes a battery such as a primary battery, a secondary battery, or a photovoltaic cell and supplies electric power to the units of the first pointer 50. The first pointer 50 may include a power switch that turns on or off the power supply from the power supply unit 57.

The second controller 58 includes a processor such as a CPU, a storage device such as a memory, and various peripheral circuits. That is, the second controller 58 includes a function serving as a computer. The processor executes a program stored in the storage device, whereby the second controller 58 controls the units of the first pointer 50. The second controller 58 may include a plurality of processors.

The second controller 58 determines, based on a control signal input from the receiver 53, light emission timing for causing the light emitter 55 to emit light. The second controller 58 causes the light emitter 55 to emit light at the determined light emission timing to output the first light 190.

### 4. Operation of the projector

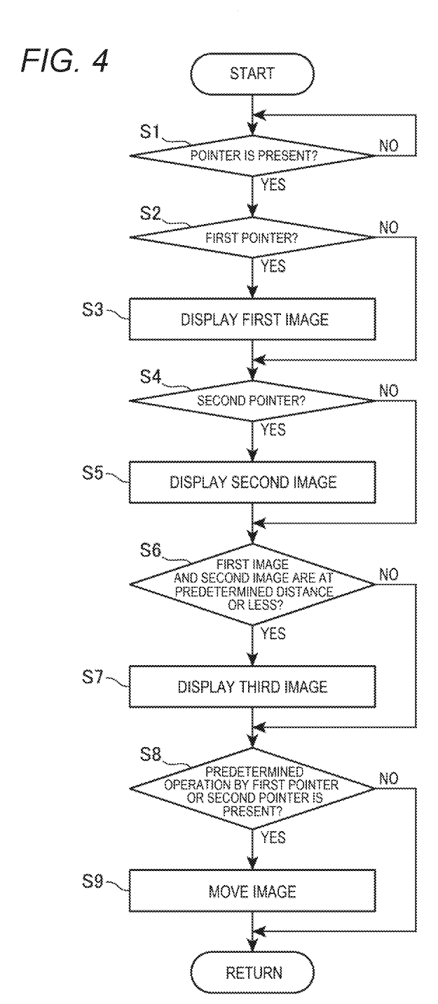

Subsequently, an operation of the projector 100 by processing executed by the first controller 150 is explained. FIG. 4 is a flowchart illustrating an operation example of the first controller 150.

As illustrated in FIG. 4, when the processing is started, the first controller 150 determines the presence or absence of a pointer in the projection region 20 corresponding to the display surface 10 based on an analysis result of a captured image generated by the imager 135 (S1). Specifically, when a light spot of the first light 190 or a light spot of the reflected light of the second light 180 detected according to the analysis result of the captured image is present, the first controller 150 determines that a pointer is present. When a pointer is absent (S1: No), the first controller 150 stands by for the processing.

When a pointer is present (S1: Yes), the first controller 150 determines whether the pointer is the first pointer 50, which is a pointing pen, (S2). Specifically, when detecting the light spot of the first light 190 according to the analysis result of the captured image, the first controller 150 determines that the pointer is the first pointer 50. When the pointer is not the first pointer 50 (S2: No), the first controller 150 skips S3 and advances the processing to S4.

When the pointer is the first pointer 50 (S2: Yes), the first controller 150 displays, on the display surface 10, a first image, which is a GUI image including a plurality of icon images for receiving an operation instruction by the first pointer 50, (S3).

Specifically, the first controller 150 reads, from the display image information 163, a plurality of icon images for receiving an operation instruction by the first pointer 50 and information such as display sizes of the plurality of icon images. The first controller 150 reads, from the display image information 163, information such as a first image to be displayed including the plurality of icon images to be displayed, a display size of the first image, and arrangement positions of the icon images in the first image. Subsequently, the first controller 150 generates drawing data for displaying the first image on the display surface 10 based on the information read from the display image information 163. Subsequently, the first controller 150 outputs the generated drawing data to the image generator 110. Here, the first controller 150 may designate a display position on the display surface 10 by the drawing data, such as the vicinity of the detected position of the first pointer 50. For example, in a state in which the detected position of the first pointer 50 is not in contact with the display surface 10, the first controller 150 generates drawing data to display the first image at a position on the display surface 10 corresponding to the position of the first pointer 50 in a space separated from the display surface 10 in the normal direction. Specifically, when the distance between the first pointer 50 and the display surface 10 is long on the Z axis, the first controller 150 generates drawing data to display the first image at a position on the display surface 10 corresponding to the position of the first pointer 50 for which only the X axis and the Y axis are considered. Accordingly, even when the first pointer 50 is not in contact with the display surface 10, the projector 100 can make it easy for the user to perform operation using the icon images of the first image.

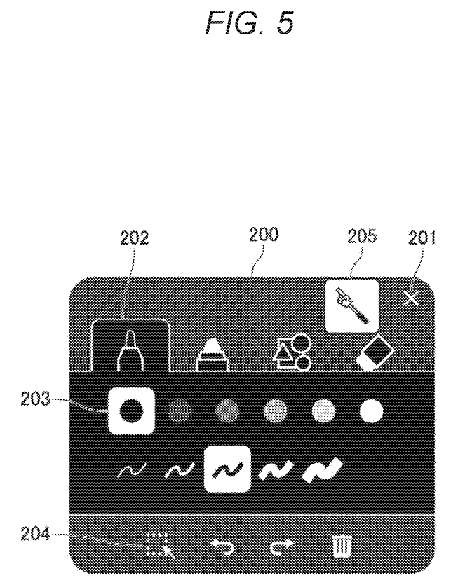

FIG. 5 is a diagram illustrating an example of the first image 200. As illustrated in FIG. 5, the first image 200 includes icon images 201 to 205 for receiving an operation instruction by the first pointer 50. The icon images 201 to 205 are examples of a first icon image.

For example, the icon image 201 is an icon image for instructing erasing of the first image 200. The icon image 201 is an icon image having the smallest area size among the icon images 201 to 205 included in the first image 200. That is, the icon image 201 is an example of a first small image.

The icon image 202 is an icon image for designating a tab for each of uses such as a pen, a fluorescent pen, a figure, and an eraser. In the illustrated example, a pen is designated by the icon image 202.

The icon image 203 is an icon image for designating various elements in a use designated by a tab. In the illustrated example, a color and thickness of a pen tip are designated by the icon image 203.

The icon image 204 is an icon image for instructing operation such as selection, cancellation, redoing, and erasing. The icon image 205 is an image representing the first image 200 indicating that the first image 200 is a GUI image for receiving an operation instruction by the first pointer 50. The icon image 205 serves as a drag position in the case in which the first image 200 is moved by an operation such as drag-and-drop. For example, the user can move the first image 200 by dragging the icon image 205 with the first pointer 50 and moving and dropping the icon image 205 to a desired position in the display surface 10.

In S3, the first controller 150 determines whether a pointer is the second pointer 70, which is a finger of the user, (S4). Specifically, when detecting the light spot of the reflected light of the second light 180 according to the analysis result of the captured image, the first controller 150 determines that the pointer is the second pointer 70. When the pointer is not the second pointer 70 (S4: No), the first controller 150 skips S5 and advances the processing to S6.

When the pointer is the second pointer 70 (S4: Yes), the first controller 150 displays, on the display surface 10, a second image, which is a GUI image including a plurality of icon images for receiving an operation instruction by the second pointer 70, (S5).

Specifically, the first controller 150 reads, from the display image information 163, a plurality of icon images for receiving an operation instruction by the second pointer 70 and information such as display sizes of the plurality of icon images. The first controller 150 reads, from the display image information 163, the second image to be displayed to include the plurality of icon images and information such as a display size of the second image and arrangement positions of the icon images in the second image. Subsequently, the first controller 150 generates, based on the information read from the display image information 163, drawing data for displaying the second image on the display surface 10. Subsequently, the first controller 150 outputs the generated drawing data to the image generator 110. Here, the first controller 150 may designate a display position on the display surface 10 by the drawing data, such as the vicinity of a detected position of the second pointer 70. For example, in a state in which the detected position of the second pointer 70 is not in contact with the display surface 10, the first controller 150 generates the drawing data to display the second image at a position on the display surface 10 corresponding to the position of the second pointer 70 in a space separated from the display surface 10 in the normal direction. Specifically, when the distance between the second pointer 70 and the display surface 10 is long in the Z axis, the first controller 150 generates the drawing data to display the second image at a position on the display surface 10 corresponding to a position of the second pointer 70 obtained by considering only the X axis and the Y axis. Accordingly, even when the second pointer 70 is not in contact with the display surface 10, the projector 100 can make it easy for the user to perform operation using the icon images of the second image.

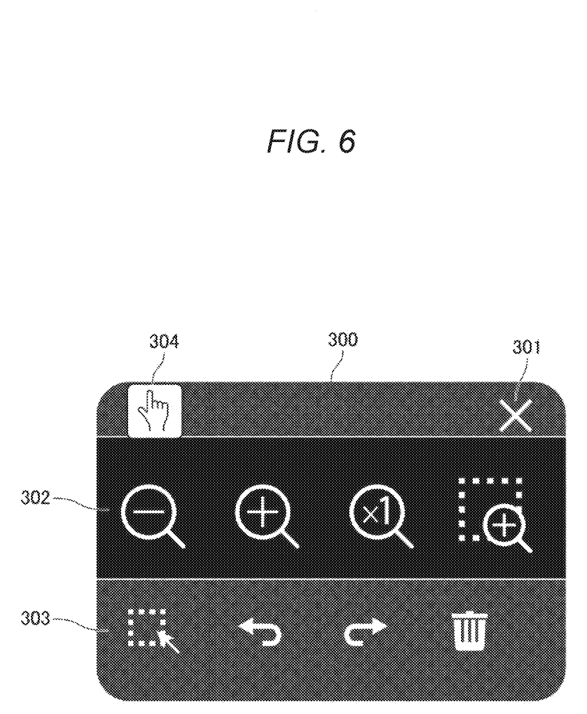

FIG. 6 is a diagram illustrating an example of the second image. As illustrated in FIG. 6, a second image 300 includes icon images 301 to 304 for receiving an operation instruction by the second pointer 70. The icon images 301 to 304 are examples of a second icon image.

For example, the icon image 301 is an icon image for instructing erasing of the second image 300. The icon image 301 is an icon image having the smallest size of an area among the icon images 301 to 304 included in the second image 300. That is, the icon image 301 is an example of a second small image.

The icon image 302 is an icon image for instructing reduction, enlargement, equal magnification, partial enlargement, or the like. For example, an image corresponding to reduction, enlargement, equal magnification, or the like included in the icon image 302 corresponds to zoom operation of, for example, reducing or enlarging an image displayed on the display surface 10 to any magnification or restoring the image to the original equal magnification. An image corresponding to the partial enlargement included in the icon image 302 corresponds to zoom operation of, for example, enlarging any portion of the image displayed on the display surface 10. The icon image 303 is an icon image for instructing operation such as selection, cancellation, redoing, and erasing. For example, an image corresponding to the selection included in the icon image 303 corresponds to operation of selecting a rectangle of any range of the display surface 10 and setting an object included in the selected rectangle to a selected state. In the projector 100, since the icon images 302 and 303 often used in operation by the second pointer 70 serving as the finger of the user, such as the zoom operation or the operation of setting the object to the selected state, are included in the second image 300, the usability for the user is improved.

The icon image 304 is an image representing the second image 300 indicating that the second image 300 is a GUI image for receiving an operation instruction by the second pointer 70. The icon image 304 serves as a drag position in the case in which the second image 300 is moved by operation such as drag-and-drop. For example, the user can move the second image 300 by dragging the icon image 304 with the second pointer 70 and moving the icon image 304 to a desired position in the display surface 10 and dropping the icon image 304.

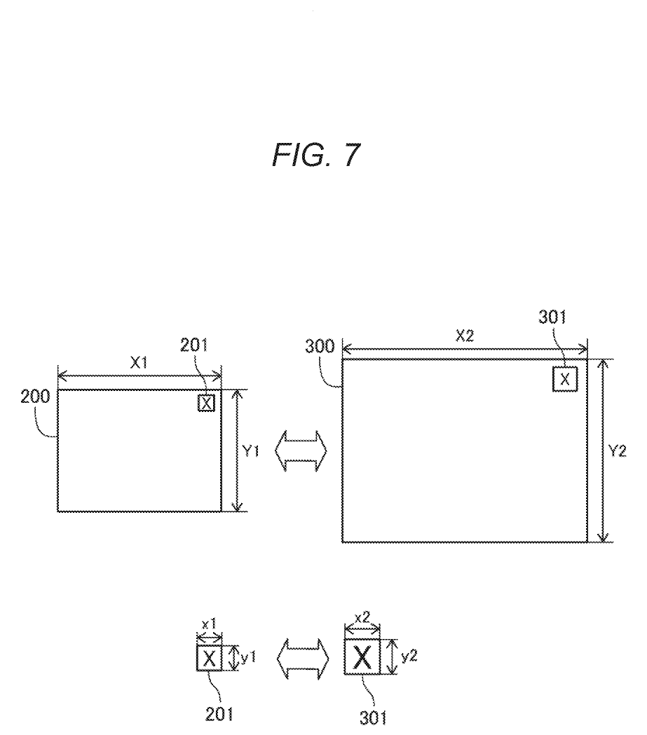

Here, the first image 200 and the second image 300 displayed on the display surface 10 and the icon image 201 having the smallest size in the first image 200 and the icon image 301 having the smallest size in the second image 300 are explained in comparison. FIG. 7 is a diagram illustrating sizes of the icon images having the smallest sizes included in the first image 200 and the second image 300.

As illustrated in FIG. 7, the first image 200 is formed in a rectangular shape with width of X1 and length of Y1. The second image 300 is formed in a rectangular shape with width of X2 and length of Y2. When display sizes of the first image 200 and the second image 300 are compared, it is preferable that X2>X1 and Y2>Y1 and that X2·Y2>X1·Y1. As explained above, by displaying the second image 300 for receiving the operation instruction by the second pointer 70, which is the finger of the user, larger than the first image 200, it is possible to improve the operability in the operation instruction by the finger of the user.

In the illustrated example, a case in which the first image 200 and the second image 300 have the rectangular shapes is exemplified. However, the shapes of the first image 200 and the second image 300 are not limited to the rectangular shapes. For example, the shapes of the first image 200 and the second image 300 may be circular or triangular shapes. The shapes of the first image 200 and the second image 300 may be different from each other. The display sizes of the first image 200 and the second image 300 are compared, the display sizes only have to be the display size of the second image 300 > the display size of the first image 200.

The icon image 201 having the smallest size in the first image 200 is formed in a rectangular shape with width of x1 and length of y1. The icon image 301 of the smallest size in the second image 300 is formed in a rectangular shape with width of x2 and length of y2. When display sizes of the icon image 201 and the icon image 301 are compared, x2>x1 and y2>y1 and x2·y2>x1·y1. As explained above, the icon image 301 having the smallest display size among the icon images for receiving the operation instruction by the second pointer 70, which is the finger of the user, has a larger display size than the display size of the smallest icon image 201 in the first image 200. As explained above, by increasing the display size of the icon image 201, it is easy to select the icon image 201 with the second pointer 70, which is the finger of the user. Therefore, it is possible to improve the operability of the user.

Referring back to FIG. 4, the first controller 150 determines whether the first image 200 and the second image 300 displayed on the display surface 10 are present at a predetermined distance or less on the display surface 10 (S6). Specifically, the first controller 150 calculates a distance between images based on a display coordinate of the first image 200 and a display coordinate of the second image 300 on display surface 10. Subsequently, the first controller 150 determines whether the calculated distance is equal to or smaller than a preset threshold. Here, the threshold used for the determination is set in advance by the user or the like.

When the first image 200 and the second image 300 are not present at the predetermined distance or less (S6: No), the first controller 150 skips S7 and advances the processing to S8.

When the first image 200 and the second image 300 are at the predetermined distance or less (S6: Yes), the first controller 150 displays, on the display surface 10, a third image including a plurality of icon images for receiving an operation instruction by at least one of the first pointer 50 and the second pointer 70 (S7).

Specifically, the first controller 150 reads, from the display image information 163, the plurality of icon images for receiving the operation instruction by at least one of the first pointer 50 and the second pointer 70 and information such as display sizes of the icon images. The first controller 150 reads, from the display image information 163, a third image to be displayed to include the plurality of icon images and information such as a display size of the third image and arrangement positions of the icon images in the third image. Subsequently, the first controller 150 generates, based on the information read from the display image information 163, drawing data for displaying the third image on the display surface 10. Subsequently, the first controller 150 outputs the generated drawing data to the image generator 110. Here, the first controller 150 may designate a display position on the display surface 10 by the drawing data, such as the vicinity of the first image 200 and the second image 300 at a short distance, for example, the vicinity of the intermediate position between the first image 200 and the second image 300.

In addition, the first controller 150 erases the first image 200 and the second image 300 that have been displayed so far from the display surface 10 by displaying the third image. Accordingly, on the display surface 10, the first image 200 and the second image 300 are combined and the third image is seen as being displayed.

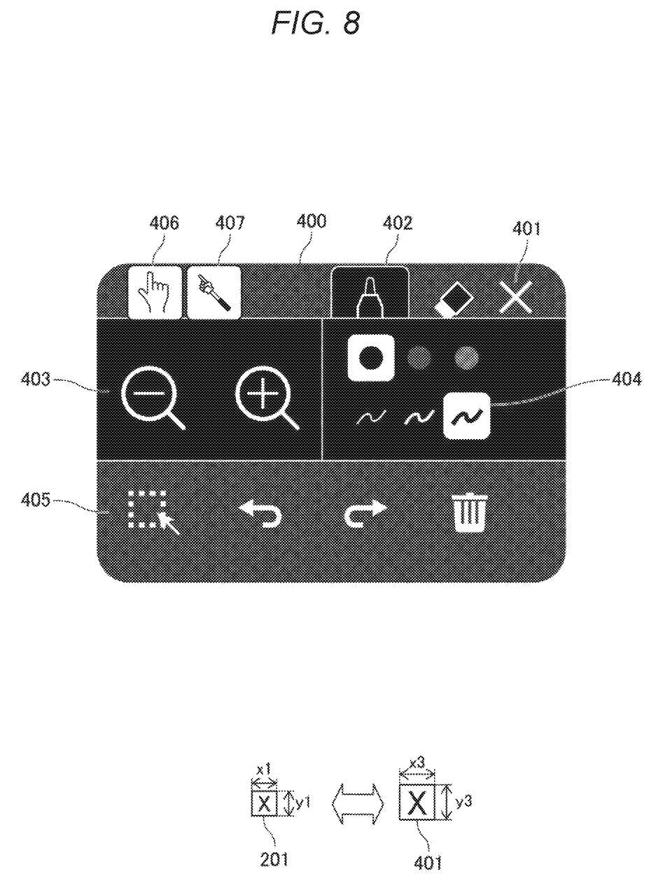

FIG. 8 is a diagram illustrating an example of a third image 400. As illustrated in FIG. 8, the third image 400 includes icon image 401 to 407 for receiving an operation instruction by at least one of the first pointer 50 and the second pointer 70. The icon images 401 to 407 are examples of a third icon image. Note that in the present embodiment, it is assumed that operation instructions of both the first pointer 50 and the second pointer 70 are received for all of the icon images 401 to 407. The icon images 401 to 407 may be divided into icon images for receiving an operation instruction of the first pointer 50, icon images for receiving an operation instruction of the second pointer 70, and icon images for receiving both of the operation instructions.

For example, the icon image 401 is an icon image for instructing erasing of the third image 400. The icon image 401 is an icon image having the smallest size of an area among the icon images 401 to 407 included in the third image 400. That is, the icon image 401 is an example of a third small image.

The icon image 402 is an icon image for designating a tab for each of uses such as a pen and an eraser. In the illustrated example, the pen is designated by the icon image 402.

The icon image 403 is an icon image for instructing reduction, enlargement, and the like. The icon image 405 is an icon image for instructing operation such as selection, cancellation, redoing, and erasing.

The icon images 406 and 407 are images representing the third image 400 indicating that the third image 400 is a GUI image for receiving an operation instruction by at least one of the first pointer 50 and the second pointer 70. The icon images 406 and 407 serve as drag positions in the case in which the third image 400 is moved by operation such as drag-and-drop or in the case in which the third image 400 is divided and restored to the original first image 200 and the original second image 300.

For example, the user can move the third image 400 by dragging at least one of the icon images 406 and 407 with the first pointer 50 or the second pointer 70 and moving the icon image to a desired position in the display surface 10 and dropping the icon image. The user drags the icon image 407 with the first pointer 50, drags the icon image 406 with the second pointer 70, and then separates the first pointer 50 and the second pointer 70 from each other. Subsequently, the user can divide the icon images 407 and 406 dragged by the first pointer 50 and the second pointer 70 into the original first image 200 and the original second image 300 by dropping the icon images 407 and 406.

Here, the icon image 204 having the smallest size in the third image 400 and the icon image 201 having the smallest size in the first image 200 displayed on the display surface 10 are explained in comparison. It is assumed that a display size of the icon image 201 is the same as the display size in FIG. 7.

As illustrated in a lower part of FIG. 8, the icon image 401 having the smallest size in the third image 400 is formed in a rectangular shape with width of x3 and length of y3. When the display sizes of the icon image 201 and the icon image 401 are compared, x3>x1 and y3>y1 and x3·y3>x1·y1. As explained above, the icon image 401 having the smallest display size among the icon images for receiving the operation instruction by the second pointer 70, which is the finger of the user, or the first pointer 50, which is the pointing pen, has a larger display size than the display size of the smallest icon image 201 in the first image 200. As explained above, by increasing the display size of the icon image 401, it is easy to select the icon image 401 with the second pointer 70, which is the finger of the user. Therefore, it is possible to improve the operability of the user.

The first controller 150 may extract an icon image of a common operation instruction out of the icon images 201 to 204 of the first image 200 and the icon images 301 to 303 of the second image 300 and then use the icon image as an icon image at the time when the third image 400 is displayed. The plurality of icons 401 to 407 include an icon image corresponding to at least one of the plurality of icon images 201 to 205 and an icon image corresponding to at least one of the plurality of icon images 301 to 304.

Specifically, since the icon images 201 and 301 for closing operation are for a common operation instruction, the first controller 150 includes the icon image 401 corresponding to the common operation instruction in the third image 400. Similarly, since the icon images 204 and 303 for instructing operation such as selection, cancellation, redoing, and erasing are for a common operation instruction, the first controller 150 includes the icon image 405 corresponding to the common operation instruction in the third image 400. Accordingly, the number of the plurality of icon images 401 to 405 is smaller than the total of the number of the icon images 201 to 204 and the number of the icon images 301 to 303.

The first controller 150 may determine, based on the history information 164, the icon images 402 to 404 to be included in the third image 400 out of the icon images 202 and 203 of the first image 200 and the icon image 302 of the second image 300. Specifically, the first controller 150 preferentially selects an icon image operated most recently and an icon image having a large number of times of operation in the history information 164.

For example, among tabs for each of uses such as a pen, a fluorescent pen, a figure, and an eraser in the icon image 202, tabs operated most recently or tabs operated many times are the pen and the eraser. In this case, as illustrated in FIG. 8, the first controller 150 selects the pen and the eraser out of the pen, the fluorescent pen, the figure, and the eraser and sets the pen and the eraser as the icon image 402. For icon images for instructing reduction, enlargement, equal magnification, partial enlargement, and the like, the first controller 150 selects icon images operated most recently or reduction or enlargement operated many times and sets the selected icon images as the icon image 403. For icon images for instructing a color and thickness of a pen tip, the first controller 150 selects three elements operated most recently and three elements in the descending order of the numbers of times of operation and sets the selected elements as the icon image 404.

Referring back to FIG. 4, the first controller 150 determines the presence or absence of predetermined operation relating to movement of the first image 200, the second image 300, or the third image 400 by the first pointer 50 or the second pointer 70 (S8).

Here, in the predetermined operation relating to the movement of the first image 200, the second image 300, or the third image 400, the movement of the first image 200 is a drag-and-drop operation for the icon image 205 representing the first image 200. The movement of the second image 300 is a drag-and-drop operation for the icon image 304 representing the second image 300. The movement of the third image 400 is a drag-and-drop operation for the icon images 406 and 407 representing the third image 400. A movement for dividing the third image 400 and restoring the third image 400 to the original first image 200 and second image 300 is an operation of dragging the icon images 406 and 407, separating the icon images 406 and 407, and then dropping the icon images 406 and 407. In the projector 100, the first image 200, the second image 300, or the third image 400 can be fixedly arranged at any positions on the display surface 10 by performing a predetermined operation such as drag-and-drop for the icon images 205, 304, 406, and 407.

Note that the operation relating to the movement explained above is an example and may be another operation. For example, the first controller 150 may move the first image 200 according to a movement of the first pointer 50 on the display surface 10. Similarly, the first controller 150 may move the second image 300 according to the movement of the second pointer 70 on the display surface 10. The first controller 150 may set, as an operation relating to the movement of the images, a flick operation in a predetermined direction by the first pointer 50 or the second pointer 70 in the vicinity of the first image 200, the second image 300, or the third image 400. The first controller 150 may set a flick operation of expanding the third image 400 further to the outer side than the center as an operation of dividing the third image 400 and restoring the third image 400 to the original first image 200 and the original second image 300.

When the predetermined operation relating to the movement of the first image 200, the second image 300, or the third image 400 is absent (S9: No), the first controller 150 skips S9 and returns the processing. When the predetermined operation relating to the movement of the first image 200, the second image 300, or the third image 400 is present (S9: Yes), the first controller 150 moves a target image on the display surface 10 (S9) and returns the processing.

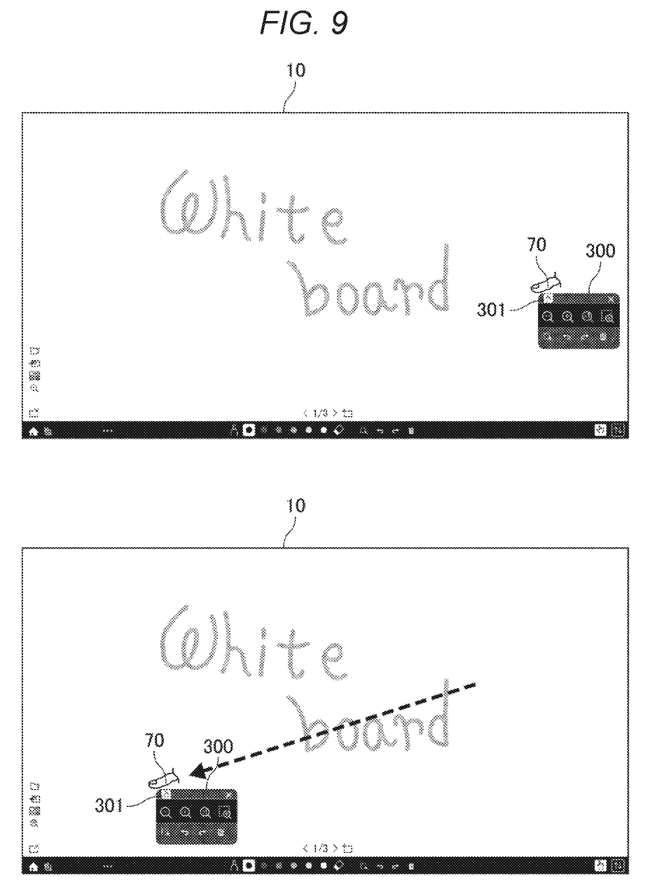

FIG. 9 is a diagram illustrating movement of the second image 300 on the display surface 10. As illustrated in FIG. 9, the user drags the icon image 301 representing the second image 300 with the second pointer 70, which is the finger of the user. Subsequently, the user can move the second image 300 by dropping the second pointer 70 after moving the second pointer 70 to a desired position on the display surface 10.

For combined display of the third image 400 in the case in which the first image 200 and the second image 300 approach, the first controller 150 may combine and display the first image 200 and the third image 400 stepwise according to a distance between the first image 200 and the second image 300.

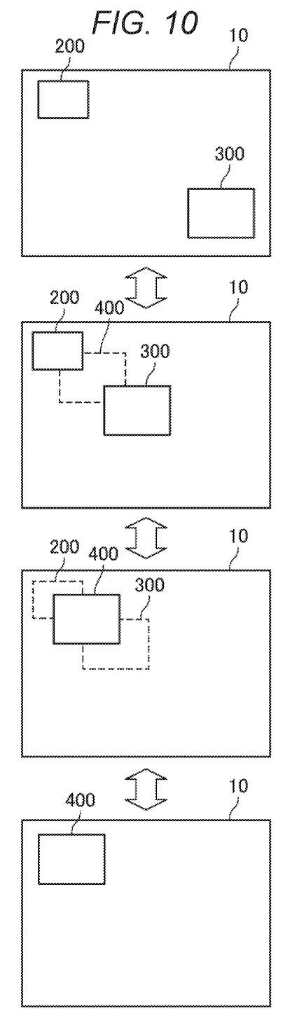

FIG. 10 is a diagram illustrating display of the third image 400 by the combination of the first image 200 and the second image 300. In an example illustrated in FIG. 10, a state in which the second image 300 approaches the first image 200 and the third image 400 is displayed is illustrated stepwise from the top to the bottom. From the bottom to the top, conversely, a state in which the third image 400 is divided into the first image 200 and the second image 300 is illustrated.

As illustrated in FIG. 10, when the first image 200 and the second image 300 approach by a predetermined distance on the display surface 10, the first controller 150 causes the display surface 10 to display the third image 400, for example at the intermediate position between the first image 200 and the second image 300. At this time, the first controller 150 displays the third image 400 as a provisional display for not receiving operation by the icon images 401 to 407. In the illustrated example, the provisional display is represented by a dotted line. That is, it is assumed that, while the third image 400 is the provisional display, the first controller 150 receives operation on the first image 200 or the second image 300.

It is assumed that, subsequently, when the first image 200 and the second image 300 further approach, the first controller 150 receives operation by the icon images 401 to 407 of the third image 400. It is assumed that, at this time, the first controller 150 provisionally displays the first image 200 and the second image 300 and does not receive operation on the first image 200 or the second image 300.

Next, when the first image 200 and the second image 300 further approach each other, the first controller 150 erases the first image 200 and the second image 300 that are provisionally displayed and displays only the third image 400 on the display surface 10.

By performing the combination display of such a process, the user can easily recognize that the first image 200 and the second image 300 are combined and the third image 400 is displayed. The user can easily recognize that the first image 200 and the second image 300 disappear according to the display of the third image 400.

Conversely, a case in which the first image 200 and the second image 300 are displayed separately from the third image 400 is explained. It is assumed that, first, an operation of separating the second image 300 from the third image 400 to the lower right is performed by dragging the icon image 406 to the lower right with respect to the icon image 407 in the third image 400.

Based on this separating operation, the first controller 150 causes the display surface 10 to display the first image 200 and the second image 300. It is assumed that, at this time, the first controller 150 provisionally displays the first image 200 and the second image 300 and does not receive operation on the first image 200 or the second image 300. That is, it is assumed that, while the first image 200 and the second image 300 are provisionally displayed, the first controller 150 receives operation on the third image 400.

It is assumed that, subsequently, when the separating operation continues, the first controller 150 receives operation on the first image 200 and the second image 300. It is assumed that, at this time, the first controller 150 provisionally displays the third image 400 and does not receive operation on the third image 400.

Subsequently, when the first image 200 and the second image 300 are further separated, the first controller 150 erases the third image 400 that is provisionally displayed and causes the display surface 10 to display only the first image 200 and the second image 300.

By performing the separation display of the process explained above, the user can easily recognize that the first image 200 and the second image 300 are separated from the third image 400. The user can easily recognize that the third image 400 disappears by being divided into the first image 200 and the second image 300.

### 5. Effects of the embodiment

As explained above, the projector 100 includes the first controller 150 including the processor 165. The first controller 150 executes determining whether the first pointer pointing a position on the display surface 10 is a pointing pen. When determining that the first pointer is the pointing pen, the first controller 150 executes causing the display surface 10 to display the first image 200 including the icon image 201 to 205 for receiving an operation instruction with the pointing pen instruction with the pointing pen. The first controller 150 executes determining whether the second pointer pointing a position on the display surface is a finger of the user. When determining that the second pointer is a finger of the user, the first controller 150 executes causing the display surface 10 to display the second image 300 including the icon images 301 to 304 for receiving an operation instruction by the finger of the user. The second small image having the smallest display size, which is one of the icon images 301 to 304, has a display size larger than a display size of the first small image having the smallest display size, which is one of the icon images 201 to 205.

For this reason, in the projector 100, the icon image 301 having the smallest display size for receiving the operation instruction by the second pointer 70, which is the finger of the user, can be displayed larger than the icon image 201 having the smallest size for receiving the operation instruction by the first pointer 50, which is the pointing pen. For this reason, the projector 100 can improve the operability by the finger of the user. For example, in the projector 100, it is possible to suppress erroneous operation in the case in which the user performs operation by the finger. In the projection system 1 using the projector 100, in a situation in which the accuracy of calibration is deteriorated, detection accuracy of a pointer is sometimes deteriorated and erroneous selection tends to occur in the operation by the finger of the user. Even when the detection accuracy of the pointer is deteriorated as explained above, in the projector 100, it is possible to prevent the operability by the finger of the user from worsening.

When the position of the first image 200 and the position of the second image 300 on the display surface 10 are at the predetermined distance or less, the first controller 150 further executes causing the display surface 10 to display the third image 400. The third image 400 includes the icon images 401 to 407 for receiving operation instructions by the first pointer 50 and the second pointer 70. The icon images 401 to 407 include an icon image corresponding to at least one of the icon images 201 to 205 and an icon image corresponding to at least one of the icon images 301 to 304.

By displaying the third image 400 explained above, in the projector 100, only one GUI for performing an operation instruction with at least one of the first pointer 50 and the second pointer 70 is sufficient. Therefore, in the projector 100, compared with when the first image 200 and the second image 300 are displayed on the display surface 10, display content on the display surface 10 can be simplified and easily viewed by the user.

Causing the display surface 10 to display the third image 400 means combining the first image 200 and the second image 300 to cause the display surface 10 to display the third image 400.

For this reason, in the projector 100, since the first image 200 and the second image 300 are combined into the third image 400 of one GUI, the display content on the display surface 10 can be simplified.

The third small image having the smallest display size, which is one of the plurality of icon images 401 to 407, is larger than the first small image having the smallest display size, which is one of the plurality of icon images 201 to 205.

For this reason, in the projector 100, the icon image 401 having the smallest display size in the third image 400 can be displayed larger than the smallest icon image 201 for receiving the operation instruction by the first pointer 50, which is the pointing pen. For this reason, the projector 100 can improve the operability of the finger of the user, for example, for the icon images in the third image 400.

The number of icon images 401 to 407 is smaller than a total of the number of icon images 201 to 205 and the number of icon images 301 to 304.

As explained above, by reducing the number of icon images 401 to 407, in the projector 100, it is possible to simplify display content in the third image 400.

The icon images 401 to 407 include icon images corresponding to a common operation instruction in the icon images 201 to 205 and the icon images 301 to 304.

As explained above, by including the icon images corresponding to the common operation instruction in the icon images 401 to 407, in the projector 100, it is possible to efficiently reduce the number of the icon images 401 to 407 in the third image 400.

The first controller 150 further executes determining, based on the history information 164 of the operation instruction, icon images to be included in the icon images 401 to 407 out of the icon images 201 to 205 and the icon images 301 to 304.

For this reason, in the projector 100, the icon images 401 to 407 corresponding to a history of operation can be used. For example, the projector 100 includes, in the icon images 401 to 407, icon images used immediately before the icon images 401 to 407. Accordingly, the user can save time and effort of searching for a desired icon image when continuously using the same operation.

The first controller 150 further executes causing the display surface 10 to display a representative image corresponding to the first image 200, the second image 300, or the third image 400. For example, the first controller 150 executes causing the display surface 10 to display the icon image 205 as a representative image of the first image 200. The first controller 150 executes causing the display surface 10 to display the icon image 304 as a representative image of the second image 300. The first controller 150 executes causing the display surface 10 to display the icon images 406 and 407 as representative images of the third image 400. The first controller 150 further executes moving the first image 200, the second image 300, or the third image 400 to a predetermined position on the display surface 10 based on a predetermined operation for the representative image by at least one of the first pointer 50 and the second pointer 70.

For this reason, the user can move the first image 200, the second image 300, or the third image 400 to a desired position on the display surface 10 with the predetermined operation for the representative image.

### 6. Other embodiments

The embodiment explained above is a preferred embodiment of the present disclosure. However, the present disclosure is not limited to the embodiment, and various modified implementations can be made without departing from the gist of the present disclosure.

For example, in the embodiment explained above, the configuration in which the projector 100 includes the irradiator 133 and the imager 135 is explained. However, at least one of the irradiator 133 and the imager 135 may be provided on the outside of the projector 100 as a separate light emitting device. A part of the functions of the first controller 150 may be mounted on a separate device provided on the outside of the projector 100. When these components are provided on the outside of the projector 100, the components may be respectively independent devices or a device may include two or more of these components.

In the embodiment explained above, the projector 100 is explained as the liquid crystal projector using the transmissive liquid crystal panel. However, the projector 100 may be a projector using a reflective liquid crystal panel or a digital mirror device.

The specifying of the positions of the first pointer 50 and the second pointer 70 on the display surface 10 is not limited to the method of detecting the light emission at the tip 51 of the first pointer 50, the reflection of the second pointer 70 for the detection light emitted along the display surface 10, or the like. For example, the projector 100 includes a stereo camera that images the projection region 20 corresponding to the display surface 10. The projector 100 specifies the positions of the first pointer 50 and the second pointer 70 on the display surface 10 based on a plurality of stereo images captured by the stereo camera. More specifically, the projector 100 specifies the first pointer 50 and the second pointer 70 included in the plurality of stereo images with a publicly known image recognition technology. Subsequently, the projector 100 specifies the positions of the tip 51 of the specified first pointer 50 and the finger tip in the specified second pointer 70 based on the difference among the plurality of stereo images. In this case, the first pointer 50 serving as the pointing pen may not cause the tip 51 to emit light or may be, for example, a rod with the tip 51 sharpened.

In the embodiment explained above, the projection system 1 is exemplified as an example of the display system. However, the display system is not limited to the projection system 1. For example, the display system of the present disclosure may be applied to a display device including a stylus serving as an example of a pointing pen or a touch panel capable of detecting a touch position by a finger of the user. Examples of the display device include an electronic blackboard device used in a conference or a presentation and a tablet terminal.

The movement of the first image 200 relating to the reception of the operation by the first pointer 50 and the second image 300 relating to the reception of the operation by the second pointer 70 is not limited to the operation on the representative image explained above. For example, the projector 100 may move the first image 200 and the second image 300 based on the positions of the first pointer 50 and the second pointer 70 detected on the display surface 10.

For example, the projector 100 may move a display position of the first image 200 according to the position of the first pointer 50 detected on the display surface 10. Similarly, the projector 100 may move a display position of the second image 300 according to the position of the second pointer 70 detected on the display surface 10. As an example, when the position of the first pointer 50 is in an upper left region of the display surface 10, the projector 100 may move the first image 200 into the region. Similarly, when the position of the second pointer 70 is in a lower right region of the display surface 10, the projector 100 may move the second image 300 into the region. Accordingly, in the projector 100, it is possible to easily perform the operation using the first image 200 or the second image 300 without the user himself or herself moving the first image 200 or the second image 300 at the position of the first pointer 50 or the second pointer 70.

The functional units of the first pointer 50 illustrated in FIG. 3 indicate functional components implemented by cooperation of hardware and software and a specific embodiment is not particularly limited. Therefore, hardware individually corresponding to the functional units 「does not always need to be implemented. It is also naturally possible to adopt a configuration in which one processor executes a program to implement functions of a plurality of functional units. A part of functions implemented by software in the embodiment explained above may be implemented by hardware and a part of functions implemented by hardware in the embodiment may be implemented by software.

For example, in the configuration of the first pointer 50 illustrated in FIG. 3, at least a part of the receiver 53, the second controller 58, the power supply unit 57, and the tip switch 54 may include an integrated circuit or another digital circuit. In the configuration of the first pointer 50, an analog circuit may be provided in at least a part of the units. The integrated circuit includes an LSI, an ASIC, and a PLD. The PLD includes, for example, an FPGA. The units may be a combination of a processor and an integrated circuit. The combination is called, for example, MCU, SoC, system LSI, or chip set.

In the configuration of the projector 100 illustrated in FIG. 3, at least a part of the transmitter 131, the irradiator 133, and the first controller 150 may include an integrated circuit IC or another digital circuit, or an analog circuit may be provided in at least a part of the units. The units may include a combination of a processor and an integrated circuit.

The application program 161 executed by the processor 165 in order to implement the display method explained above may be provided by being recorded in a recording medium readable by the processor 165. The recording medium readable by the processor 165 may be an optical recording medium such as a DVD, a semiconductor memory device such as a USB memory or an SSD, or the like. The application program 161 may be provided in a form of a transmission medium that is stored on a computer connected to a network such as the Internet and is provided or distributed by being downloaded through a network.

The processing units of the flowchart illustrated in FIG. 4 are divided according to the main processing content in order to facilitate understanding of the processing of the first controller 150. The present disclosure is not limited by the way of division or the names of the processing units illustrated in the flowchart of FIG. 4. The processing of the first controller 150 can be divided into more processing units according to the processing content or can be divided such that one processing unit includes more processing. The processing order of the flowchart explained above is not limited to the illustrated example.

### 7. Summary of the present disclosure

A summary of the present disclosure is appended below.

### Appendix 1

A display method including executing, with a processor: determining whether a first pointer pointing a position on a display surface is a pointing pen; when it is determined that the first pointer is the pointing pen, causing the display surface to display a first image including a plurality of first icon images for receiving an operation instruction with the pointing pen instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

Accordingly, the smallest second small image among the plurality of second icon images for receiving the operation instruction by the finger of the user can be displayed in a large display size with respect to the smallest first small image among the plurality of first icon images for receiving the operation instruction with the pointing pen instruction with the pointing pen. It is possible to improve the operability by the finger of the user.

### Appendix 2

The display method described in Appendix 1, further executing, with the processor, when a position of the first image and a position of the second image on the display surface are at a predetermined distance or less, causing the display surface to display a third image including a plurality of third icon images for receiving the operation instructions with the pointing pen and the finger of the user, wherein the plurality of third icon images include an icon image corresponding to at least one of the plurality of first icon images and an icon image corresponding to at least one of the plurality of second icon images.

Accordingly, only one image for receiving the operation instructions with the pointing pen and the finger of the user is sufficient. Therefore, display content on the display surface is simplified and is easily seen by the user.

### Appendix 3

The display method described in Appendix 2, wherein the displaying the third image on the display surface is displaying the third image by combining the first image and the second image.

Accordingly, the first image and the second image are combined into one third image. Therefore, display content on the display surface is simplified and is easily seen by the user.

### Appendix 4

The display method described in Appendix 2 or 3, wherein a third small image having a smallest display size, which is one of the plurality of third icon images, is larger than a first small image having a smallest display size, which is one of the plurality of first icon images.

Accordingly, it is possible to improve the operability of the finger of the user for the plurality of third icon images.

### Appendix 5

The display method described in any one of Appendixes 2 to 4, wherein a number of the plurality of third icon images is smaller than a total of a number of the plurality of first icon images and a number of the plurality of second icon images.

Accordingly, since the number of the plurality of third icon images is small, display content of the third image is simplified and is more easily seen by the user.

### Appendix 6

The display method described in any one of Appendixes 2 to 5, wherein the plurality of third icon images include an icon image corresponding to a common operation instruction in the plurality of first icon images and the plurality of second icon images.

Accordingly, the number of the plurality of third icon images can be efficiently reduced.

### Appendix 7

The display method described in any one of Appendixes 2 to 6, further executing, with the processor, determining, out of the plurality of first icon images and the plurality of second icon images, based on history information of operation instructions, an icon image to be included in the plurality of third icon images.

Accordingly, the icon image to be included in the plurality of third icon images out of the plurality of first icon images and the plurality of second icon images is an icon image corresponding to the history of the operation instructions, for example, an icon image continuously used for the same operation. Therefore, the user can save time and effort for searching for a frequently used icon image, for example, an icon image continuously used for the same operation.

### Appendix 8

The display method described in any one of Appendixes 2 to 7, further executing, with the processor: displaying a representative image corresponding to the first image, the second image, or the third image on the display surface; and moving the first image, the second image, or the third image to a predetermined position on the display surface based on a predetermined operation for the representative image by at least one of the pointing pen and the finger of the user.

Accordingly, the user can move the first image, the second image, or the third image to a desired position on the display surface with the predetermined operation for the representative image.

### Appendix 9

A display system including a processor configured to execute: determining whether a first pointer pointing a position on a display surface is a pointing pen; when it is determined that the first pointer is the pointing pen, causing the display surface to display a first image including a plurality of first icon images for receiving an operation instruction with the pointing pen instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

Accordingly, the smallest second small image among the plurality of second icon images for receiving the operation instruction by the finger of the user can be displayed in a large display size with respect to the smallest first small image among the plurality of first icon images for receiving the operation instruction with the pointing pen instruction with the pointing pen. It is possible to improve the operability by the finger of the user.

### Appendix 10

A non-transitory computer-readable storage medium storing a display program for causing a processor to execute: determining whether a first pointer pointing a position on a display surface is a pointing pen; when it is determined that the first pointer is the pointing pen, causing the display surface to display a first image including a plurality of first icon images for receiving an operation instruction with the pointing pen ; determining whether a second pointer pointing a position on the display surface is a finger of a user; and, when it is determined that the second pointer is the finger of the user, causing the display surface to display a second image including a plurality of second icon images for receiving an operation instruction by the finger of the user, wherein a second small image having a smallest display size, which is one of the plurality of second icon images, is larger than a first small image having a smallest display size, which is one of the plurality of first icon images.

Accordingly, the smallest second small image among the plurality of second icon images for receiving the operation instruction by the finger of the user can be displayed in a large display size with respect to the smallest first small image among the plurality of first icon images for receiving the operation instruction with the pointing pen. It is possible to improve the operability by the finger of the user.

What is claimed is:

1. A display method comprising executing, with a processor:
determining whether a first pointer pointing a position on a display surface is a pointing pen;
when it is determined that the first pointer is the pointing pen, causing the display surface to display a first image including a plurality of first icon images for receiving an operation instruction with the pointing pen ;
determining whether a second pointer pointing a position on the display surface is a finger of a user; and
when it is determined that the second pointer is the finger of the user, causing the display surface to display a second image including a plurality of second icon images for receiving an operation instruction by the finger of the user, wherein
a second small image having a smallest display size, which is one of the plurality of second icon images, is larger than a first small image having a smallest display size, which is one of the plurality of first icon images.

2. The display method according to claim 1, further executing, with the processor, when a position of the first image and a position of the second image on the display surface are at a predetermined distance or less, causing the display surface to display a third image including a plurality of third icon images for receiving the operation instructions with the pointing pen and the finger of the user, wherein
the plurality of third icon images include an icon image corresponding to at least one of the plurality of first icon images and an icon image corresponding to at least one of the plurality of second icon images.

3. The display method according to claim 2, wherein the displaying the third image on the display surface is displaying the third image by combining the first image and the second image.

4. The display method according to claim 2, wherein a third small image having a smallest display size, which is one of the plurality of third icon images, is larger than a first small image having a smallest display size, which is one of the plurality of first icon images.

5. The display method according to claim 2, wherein a number of the plurality of third icon images is smaller than a total of a number of the plurality of first icon images and a number of the plurality of second icon images.

6. The display method according to claim 5, wherein the plurality of third icon images include an icon image corresponding to a common operation instruction in the plurality of first icon images and the plurality of second icon images.

7. The display method according to claim 2, further executing, with the processor, determining, out of the plurality of first icon images and the plurality of second icon images, based on history information of operation instructions, an icon image to be included in the plurality of third icon images.

8. The display method according to claim 2, further executing, with the processor:
displaying a representative image corresponding to the first image, the second image, or the third image on the display surface; and
moving the first image, the second image, or the third image to a predetermined position on the display surface based on a predetermined operation for the representative image by at least one of the pointing pen and the finger of the user.

9. A display system comprising a processor configured to execute:
determining whether a first pointer pointing a position on a display surface is a pointing pen;
when it is determined that the first pointer is the pointing pen, causing the display surface to display a first image including a plurality of first icon images for receiving an operation instruction with the pointing pen ;
determining whether a second pointer pointing a position on the display surface is a finger of a user; and
when it is determined that the second pointer is the finger of the user, causing the display surface to display a second image including a plurality of second icon images for receiving an operation instruction by the finger of the user, wherein
a second small image having a smallest display size, which is one of the plurality of second icon images, is larger than a first small image having a smallest display size, which is one of the plurality of first icon images.

10. A non-transitory computer-readable storage medium storing a display program for causing a processor to execute:
determining whether a first pointer pointing a position on a display surface is a pointing pen;
when it is determined that the first pointer is the pointing pen, causing the display surface to display a first image including a plurality of first icon images for receiving an operation instruction with the pointing pen ;
determining whether a second pointer pointing a position on the display surface is a finger of a user; and
when it is determined that the second pointer is the finger of the user, causing the display surface to display a second image including a plurality of second icon images for receiving an operation instruction by the finger of the user, wherein
a second small image having a smallest display size, which is one of the plurality of second icon images, is larger than a first small image having a smallest display size, which is one of the plurality of first icon images.
